(19) United States
(12) Patent Application Publication
(10) Pub. No.: US 2026/0350682 A1
(43) Pub. Date: Nov. 5, 2026

(54) Category-Based Recommendations Using Large Language Models

(71) Applicant: Maplebear Inc., San Francisco, CA (US)

(72) Inventors: Trace Levinson, Brooklyn, NY (US); Pramod Adiddam, Mountain View, CA (US)

(21) Appl. No.: 19/195,441

(22) Filed: Apr. 30, 2025

(51) Int. Cl. G06Q 30/0601; G06F 40/40

(52) U.S. Cl. CPC G06Q 30/0631; G06F 40/40

(57) ABSTRACT

Embodiments for large language model (LLM) and classification stimuli driven item recommendation are described. An online system gathers performance data describing actions of a user in response to previously made classification stimulus-based item recommendations. The online system prompts a LLM based in part on a list of classifications of items and the performance data to generate a set of classifications of items that are predicted to be of interest to the user. The online system selects a classification that is part of the set based in part on stimuli associated with a subset of the set, and the subset includes the selected classification. The online system selects one or more items belonging to the classification, and provides one or more item recommendations for the one or more items to a user device associated with the user for presentation.

### BACKGROUND

Conventional online commerce platforms may present incentives encouraging users to purchase products within certain categories. However, these platforms typically apply incentives at a global level across the user base, without accounting for whether an individual user is likely to be influenced by a category-specific incentive. As a result, these systems lack the ability to personalize category-based incentives in a way that meaningfully impacts user behavior. Furthermore, even when personalization is attempted, there exists no effective real-time or pseudo-real-time data feed that provides reliable guidance for selecting an appropriate product category to incentivize on a per-user basis.

Conventional machine learning approaches struggle to effectively select and rank product categories for targeted incentives in real-time contexts. In particular, traditional methods face significant limitations due to the complexity of feature engineering and the sparsity of meaningful user signals. Feature selection can be both labor-intensive and brittle, requiring frequent updates to remain effective. Attempts to use embedding-based representations of user sessions and context often fail to capture the nuanced, high-dimensional relationships between user behavior, product categories, and incentive responsiveness.

Accordingly, there exists a need for a technical solution that enables more effective, context-aware selection of product categories for incentivization at the individual user level, while reducing the reliance on manually engineered features and improving the adaptability of the system to evolving user behavior and product taxonomies.

### SUMMARY

In accordance with one or more aspects of the disclosure, embodiments for large language model (LLM) and classification stimuli driven item recommendation are described. An online system may gather performance data describing actions of a user in response to previously made classification stimulus-based item recommendations. The online system may prompt a LLM (e.g., a classification preference model) based in part on a list of classifications of items and the performance data to generate a set of classifications of items that are predicted to be of interest to the user. In some embodiments, the set of classifications of items may be composed of classifications that are new to the user or classifications that the user rarely purchases items belonging to. The online system may select a classification that is part of the set based in part on classification stimuli (e.g., incentives that apply to all items of a classification) associated with a subset of the set, where the subset includes the selected classification. The online system may select one or more items belonging to the classification, and provide one or more item recommendations for the one or more items to a user device associated with the user for presentation. In some embodiments, the online system may also provide the classification stimulus or the selected classification to the user device for presentation.

In the above manner, the online system uses the LLM and classification stimuli (e.g., represented in the subset) to provide item recommendations to the user device. Unlike conventional recommendation engines that rely on manually engineered features or static embeddings to score categories, the LLM-based approach leverages a flexible, unstructured input format and captures session context and user behavior in a more expressive and adaptive way. This enables more accurate classification selection and improves recommendation relevance across diverse user profiles and item taxonomies. Additionally, because the system can incorporate updated performance data as feedback over time, the LLM may be fine-tuned or prompt-tuned in a continuous or iterative manner. This adaptability eliminates the need for frequent retraining or reengineering of upstream features, thus improving system maintainability and scalability. As a result, the system achieves a more technically efficient and responsive method for delivering real-time, personalized category-based incentives within an online platform.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with some embodiments.

FIGS. 3A-3B form an example sequence diagram for large-language model and classification stimuli driven item recommendation, in accordance with some embodiments.

FIG. 4 illustrates an example ordering interface presenting a classification stimulus and an item carousel for items subject to the classification stimulus, in accordance with some embodiments.

FIG. 5 is a flowchart for a method of leveraging a classification preference model and classification stimuli for making item recommendations that are subject to at least one classification stimulus, in accordance with some embodiments.

### DETAILED DESCRIPTION

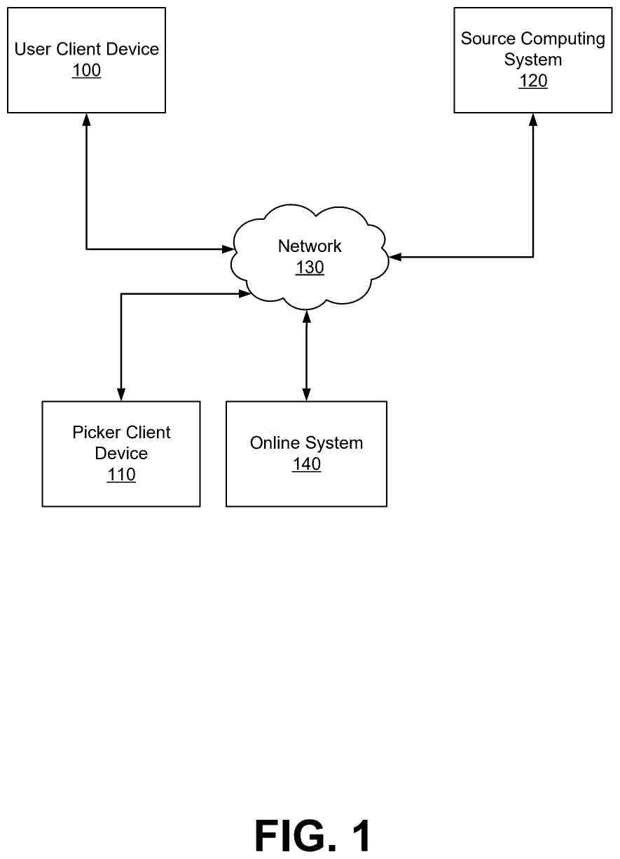

FIG. 1 illustrates an example system environment for an online system 140, in accordance with one or more embodiments. The system environment illustrated in FIG. 1 includes a user client device 100, a picker client device 110, a source computing system 120, a network 130, and an online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 may be referred to as a “user device.” The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface may present one or more storefronts for different source computing systems 120 or the online system 140. A storefront may be presented as part of a page that includes an item area that lists a plurality of item recommendations for items that are for sale. The ordering interface allows the user to search for items that are available through the online system 140 and the user can select which items to add to an “ordering list.” A “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

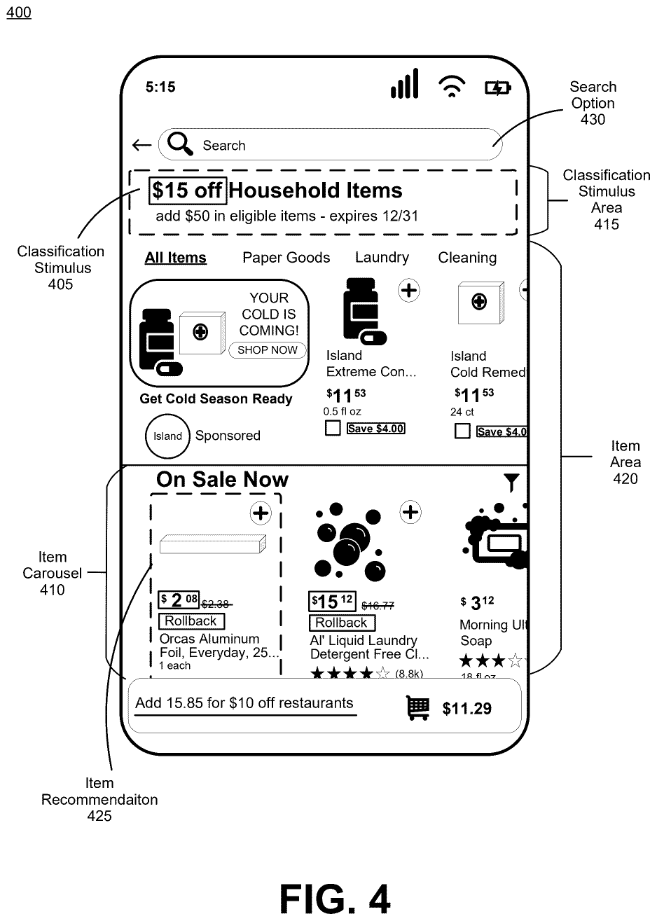

The ordering interface provides opportunities (e.g., storefront, during checkout, searching for items, etc.) for the online system 140 to present item recommendations for items of particular classifications (e.g., dairy, household goods, lawn & garden, etc.), and in some cases one or more stimuli (e.g., incentives, deals, promotions, etc.) associated with the items. The ordering interface may present item recommendations in an item area. In some embodiments, the item area may include an item carousel for presenting item recommendations. In some embodiments, the item carousel is for item recommendations for items having a same item classification and that are subject to a same classification stimulus. An item classification, more generally referred to as a “classification,” is a set of items that are a similar type (e.g., dairy) of item. A classification stimulus is a stimulus (e.g., deal, promotion, incentive, etc.) that applies to any item within a given classification. The item carousel or the item recommendations of the item carousel may be received from the online system 140. In some embodiments, the ordering interface may also receive, from the online system 140 for presentation, a classification stimulus (e.g., 10% off incentive) that applies to one or more classifications (e.g., meat or produce) of items. The ordering interface may present the classification stimulus in, e.g., a classification stimulus area of the ordering interface. In some embodiments, the ordering interface may present the stimulus along with an item carousel that is for item recommendations for items that are subject to the classification stimulus. An example of the ordering interface is shown and described below with regard to FIG. 4.

In some embodiments, the user client device 100 may provide feedback to the online system 140. The feedback may, for example, describe actions of the user responsive to presentation of an item recommendation associated with a classification, presentation of a stimulus associated with the item recommendation, or both.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real-time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user's order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. In some embodiments, the source computing system 120 provides the online system 140 with stimulus data describing available classification stimuli (e.g., incentives, deals, promotions, etc.) for different item classifications of items. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 may use classification stimuli to incentivize users to purchase items of particular classifications. For a user of the user client device 100, the online system 140 gathers performance data associated with the user (and in some instances other users as well). The performance data describes the actions (e.g., item added to ordering list, purchased item, etc.) of the user (and in some cases other users as well) in response to previously made classification-based recommendations for items. And in some embodiments, the previously made classification-based recommendations for items may have been subject to one or more classification stimuli. The online system 140 may prompt a classification preference model (e.g., an LLM) based in part on classification data and the performance data to generate a set of classifications of items. The classification data is a list of classifications of items for some or all of the items that are part of an online catalog of the online system 140. For example, the classification data may describe all classifications used to classify items that are part of the online catalog. The set of classifications of items output by the classification preference model is composed of one or more classifications (of the classification data) that are predicted to be of interest to the user. In some embodiments, the set of classifications of items may be composed of classifications that are new to the user or classifications that the user rarely purchases items belonging to. This may be useful to, e.g., encourage users to purchase items in classifications outside of what they immediately were looking for, but are likely interested in purchasing. The online system 140 may generate sets of classifications for some or all of the users in a batch (e.g., daily), generate sets of classifications in response to requests for content from the user client devices, or both.

The online system 140 may use classification stimuli (e.g., incentives, promotions, etc.) to incentivize users to purchase items of particular classifications. For example, responsive to an opportunity (e.g., the online system 140 receives a request for item recommendations from the user client device 100) to provide content to the user client device 100, the online system 140 may select a classification from a subset of classifications within the set (output from the classification preference model), and each respective classification of the subset is subject to at least one classification stimulus. For example, the set of classifications of items for a user may include: “Dairy,” “Household Items,” and “Lawn and Garden.” But only two of the categories are subject to a classification stimulus, e.g., “Dairy” with a classification stimulus of “10% off,” and “Lawn and Garden” with a classification stimulus of “spend $30, get a $5 credit on your next lawn and garden purchase.” As such, in this example, the subset of classifications for the user would include Dairy and Lawn and Garden, but not Household Items. In this manner the selected classification is subject to at least one classification stimulus.

The online system 140 may select one or more items belonging to the selected classification, and provide item recommendation(s) for the selected one or more items to the user client device 100 for presentation (e.g., via the ordering interface). In some embodiments, the item recommendation(s) are to be presented in an item carousel that is configured to present item recommendations for items of the selected classification. For example, the online system 140 may generate an item carousel that includes an item recommendation for each of the selected one or more items, and provide the item carousel to the user client device 100 for presentation. In some embodiments, the online system 140 may also provide the classification or classification stimulus associated with the classification to the user client device 100 for presentation via the ordering interface.

The online system 140 may also fine tune the classification preference model based in part on feedback collected from the user client devices. The feedback may describe, e.g., user actions in response to being presented with an item of a particular category, whether the item was subject to a stimulus, whether the stimulus was presented to the user, etc.

In the above manner, the online system 140 uses the classification preference model and classification stimuli to provide item recommendations to the user device. Moreover, the performance data for a user may change over time and the classification preference model may be tuned on feedback from the user device thereby providing a guide that can be used to better customize selection of classifications of items by the classification preference model.

The online system 140 is an online system by which users can order items to be provided to them by a picker from a source. The online system 140 receives orders from a user client device 100 through the network 130. The online system 140 selects a picker to service the user's order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

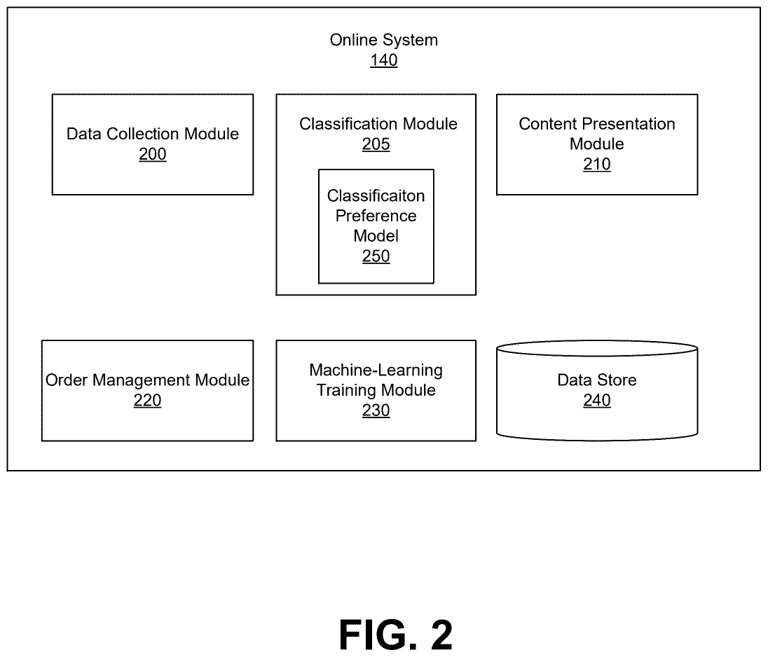

As an example, the online system 140 may allow a user to order groceries from a grocery store source. The user's order may specify which groceries they want to be delivered from the grocery store and the quantities of each of the groceries. The user's client device 100 transmits the user's order to the online system 140 and the online system 140 selects a picker to travel to the grocery store source location to collect the groceries ordered by the user. The online system transmits an offer to the picker for the picker to service the order in exchange for consideration and, if the picker accepts the offer, the picker collects the groceries from the grocery store. Once the picker has collected the groceries ordered by the user, the picker delivers the groceries to a location transmitted to the picker client device 110 by the online system 140. The online system 140 is described in further detail below with regards to FIG. 2.

FIG. 2 illustrates an example system architecture for an online system 140, in accordance with some embodiments. The system architecture illustrated in FIG. 2 includes a data collection module 200, a classification module 205, a content presentation module 210, an order management module 220, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, or stored payment instruments. The user data also may include default settings established by the user, such as a default source/source location, payment instrument, delivery location, or delivery timeframe. The data collection module 200 may collect the user data from sensors on the user client device 100 or based on the user's interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from a source computing system 120, a picker client device 110, or the user client device 100.

A classification is a set of items that are a similar type of item. Items in a classification may be considered to be equivalent to each other or may be replacements for each other in an order. For example, different brands of sourdough bread may be different items, but these items may be in a “sourdough bread” classification. The classifications may be human-generated and human-populated with items. The classifications also may be generated automatically by the data collection module 200 (e.g., using a clustering algorithm). The classifications together form classification data that is collected by the data collection model. Classification data is a list of classifications for some or all of the classifications of an online catalog of the online system 140. The data collection module 200 may store the classification data in the data store 240.

The data collection module 200 collects stimulus data. The data collection module 200 may collect the stimulus data from, e.g., one or more source computing systems (e.g., the source computing system 120). The stimulus data describes which classification stimuli are available for particular classifications of items. A classification stimulus is a stimulus (e.g., incentive, deal, promotion, etc.) that applies to all items of a classification. For example, a classification stimulus may be some number of dollars off for items belonging to a particular classification (e.g., dairy, household goods, etc.), a credit for a certain amount that is applied to an account of the user for use with future orders, etc.

The data collection module 200 collects performance data associated with users. Performance data, for a given user, is data that describes in part actions of the user (associated with a user client device) in response to previously made classification stimulus-based item recommendations. For example, the performance data may describe whether the user purchased an item subject to a classification stimulus, whether the user added the item to their ordering list, whether the user clicked into the item, whether an item recommendation for the item was presented (e.g., presented on the display of the user client device for at least a threshold period of time), some other action relating to the item, or some combination thereof. Additionally, in some embodiments, the performance data may also describe actions of other users (associated with other user client devices) in response to previously made classification stimulus-based item recommendations that were made for those users.

The data collection module 200 also collects picker data, which is information or data that describes characteristics of pickers. For example, the picker data for a picker may include the picker's name, the picker's location, how often the picker has serviced orders for the online system 140, a user rating for the picker, which sources the picker has collected items at, or the picker's previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker's performance for an order may be order data and picker data.

The classification module 205 selects classifications of items that are predicted to be of interest to users. The classification module 205 retrieves classification data (e.g., a list of classifications of items that are used in the online catalog) from the data store 240. The classification module 205, for a user associated with a user client device, generates a prompt for a classification preference model 250 to generate a set of classifications of items. The classification preference model 250 is a large language model (LLM) that is configured to, responsive to a prompt that includes the classification data and performance data associated with the user, output a set of classifications of items that are predicted to be of interest to the user. The classification module 205 prompts the classification preference model 250 based in part on the list of classifications of items (i.e., the classification data) and the performance data to generate the set of classifications of items that are predicted to be of interest to the user. The generated set of classifications is a subset of the list of classifications of items which correspond to classifications that are predicted to be of interest to the user. In some embodiments, the classification preference model 250 is trained such that the set of classifications of items that are output are for classifications that are new to the user (may be referred to as “new classifications”), classifications for items that the user rarely purchases items belonging to (may be referred to as “rarely used classifications”), or some combination thereof. A rarely used classification may be, e.g., a classification having items that a user purchases less than once per 10 orders, a classification having items that a user purchases less than once a month, etc. The classification preference model 250 also scores the set of the classifications of items. The score of a classification may, e.g., describe how likely the user is to convert items having that classification.

In some embodiments, the classification module 205 generates, for some or all of the users, respective sets of classifications of items in batch. For example, the classification module 205 may generate respective sets of classifications of items for different users in accordance with some schedule (e.g., daily, after some level of activity of the user with the online system 140 is achieved (e.g., after an order is placed), etc.). In other embodiments, the classification module 205 dynamically generates a set of classifications for a user in response to a request for content from a user client device associated with the user.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may determine a set of classifications that each have at least one classification stimulus. The content presentation module 210 may determine the set of classifications that each have at least one classification stimulus using the stimulus data. For example, the stimulus data may specify one or more classification stimuli for specific classifications. The content presentation module 210 may store the determined set of classifications that each have at least one stimulus in the data store 240.

Responsive to a request for content from a user client device associated with a user, the content presentation module 210 selects a classification having a classification incentive from the set of classifications of items that is associated with that user. The set of classifications of items that is associated with the user may include one or more classifications that are not subject to a classification stimulus, one or more classifications that are subject to a classification stimulus, or both. The selection is based in part on classification stimuli associated with a subset of the set of classifications of items associated with the user. In this manner, the content presentation module 210 can narrow the set of classifications of items to a subset that only includes classifications that are subject to at least one classification stimulus. For example, the content presentation module 210 may determine a set of classifications that each have at least one classification stimulus. The content presentation module 210 may determine one or more classifications of the set of classifications of items that is associated with the user that are also in the set of classifications that each have at least one stimulus, where the determined one or more classifications form a subset. The content presentation module 210 may rank the one or more classifications in accordance with their respective scores. The content presentation module 210 may select a classification of items from the subset based in part on its rank. For example, the content presentation module 210 may select, from the subset, a classification of items that has a highest rank. The selected classification of items, as it is part of the subset, is associated with at least one stimulus classification.

The content presentation module 210 selects items belonging to the selected classification of items for providing to the user client device. The content presentation module 210 may identify one or more items that are part of the selected classification and that the user is most likely to order. The content presentation module 210 generates an item recommendation for each of the one or more selected items and provides the generated one or more item recommendations to the user client device. In some embodiments the content presentation module 210 may generate an item carousel that includes the generated item recommendations, and provides the item carousel to the user client device 100 for presentation. In some embodiments, the content presentation module 210 also provides, for presentation, the classification stimulus associated with the item or the selected classification to the user client device for presentation.

The content presentation module 210 may use an item selection model to score items for presentation to a user. In some embodiments, the scored items may be part of the selected classification. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from a user client device 100 and offers the orders to pickers for service based on picker data. For example, the order management module 220 offers an order to a picker based on the picker's location and the location of the source from which the ordered items are to be collected. The order management module 220 may also offer an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 230 trains machine-learning models (e.g., the classification preference model 250) used by the online system 140. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, order data, stimulus data, performance data, or classification data, which may be referred to respectively as training user data, training picker data, training item data, training order data, training stimulus data, training performance data, or training classification data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

For example, the machine-learning training module 230 may train the classification preference model 250 by accessing a set of training examples that includes training performance data, training classification data, and in some embodiments may include other forms of training data (e.g., training order data, training stimulus data, etc.). The machine-learning training module 230 may apply the classification preference model 250 to the set of training examples to generate a training output corresponding to a set of training classifications of items. The machine-learning training module 230 may back-propagate one or more error terms obtained from one or more loss functions to update a set of parameters of the classification preference model 250, and one or more of the error terms are based on a difference between a label applied to a test interaction of the set of training examples and the set of training classifications of items. The machine-learning training module 230 may stop the back-propagation after the one or more loss functions satisfy one or more criteria.

In some embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

For example, the machine-learning training module 230 may fine tune the classification preference model 250 based in part on feedback from user client devices. The machine-learning training module 230 may determine feedback that is based in part on presentation of the item recommendations by the user client device. The feedback is based in part on presentation of item recommendations that have classification stimuli. The feedback may describe actions (e.g., purchase item, click into item recommendation, etc.) of users responsive to, e.g., presentation of an item recommendation associated with a classification subject to a classification stimulus, presentation of the classification stimulus associated with the item recommendation, or both. The machine-learning training module 230 may generate additional training examples based in part on the feedback. The machine-learning training module 230 may fine tuning the classification preference model 250 using the additional training examples.

The data store 240 stores data used by the online system 140. For example, the data store 240 stores user data, item data, order data, picker data, classification data, stimulus data, performance data, and feedback from user client devices for use by the online system 140. The data store 240 also stores trained machine-learning models (e.g., the classification preference model 250) trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

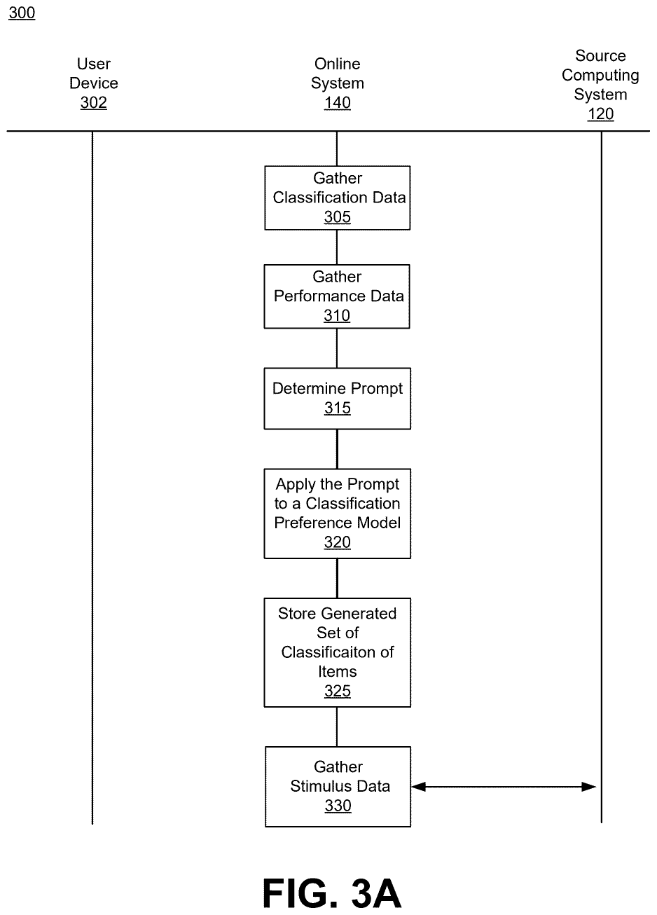

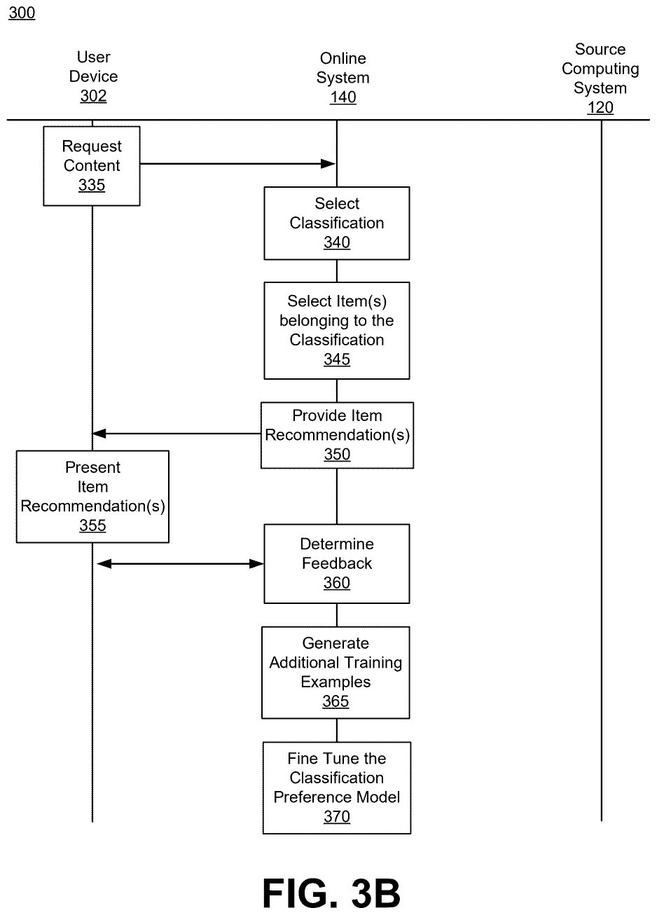

FIGS. 3A-3B form an example sequence diagram 300 for model and classification stimuli driven item recommendation, in accordance with some embodiments. Alternative embodiments may include more, fewer, or different interactions from those illustrated in FIGS. 3A-3B, and the steps may be performed in a different order from that illustrated in FIGS. 3A-3B.

The online system 140 gathers 305 classification data. For example, the online system 140 may gather the classification data from a data store (e.g., the data store 240). The online system 140 may determine the classification data using, e.g., a clustering algorithm.

The online system 140 gathers 310 performance data associated with a user of a user device 302 (e.g., the user client device 100). The performance data describes in part actions of the user (in response to previously made classification stimulus-based item recommendations. Additionally, in some embodiments, the performance data may also describe actions of other users (associated with other user devices) in response to previously made classification stimulus-based item recommendations that were made for those users. In some embodiments, the online system 140 may determine the performance data based in part on feedback previously determined from actions of the user in response to previously made classification stimulus-based item recommendations. In some embodiments, the online system 140 may retrieve performance data that had been previously determined from the data store. For example, the online system 140 may periodically (e.g., daily) determine performance data for some or all of the users, and then store the determined performance data in the data store.

The online system 140 determines 315 a prompt for a classification preference model (e.g., the classification preference model 250). For example, the online system 140 may generate or update a prompt for the classification preference model to generate a set of classifications of items that is predicted to be of interest to the user. The prompt is based in part on the classification data (e.g., the list of classifications of items) and the performance data associated with the user.

The online system 140 applies 320 the prompt to the classification preference model. Responsive to the prompt, the classification preference model outputs a set of classifications of items that are predicted to be of interest to the user, where each of the classifications are scored. The score of a classification may describe, e.g., how likely the user is to convert items having that classification. In some embodiments, the classification preference model is trained such that the set of classifications of items is composed only of new classifications or rarely used classifications. At this stage, the set of classifications of items that is associated with the user may include one or more classifications that are not subject to a classification stimulus, one or more classifications that are subject to a classification stimulus, or both.

The online system 140 stores 325 the set of classification of items in the data store. In some embodiments, steps 305-325 are performed periodically (e.g., daily) such that the set of classification of items associated with the user in the data store is current.

The online system 140 gathers 330 stimulus data. For example, the online system 140 may gather the stimulus data from the source computing system 120 or the data store. The online system 140 may periodically (e.g., daily) gather the stimulus data. In some embodiments, updates to the stimulus data may be pushed to the online system 140 from the source computing system 120. The stimulus data describes a set of one or more classifications of items which are subject to, respectively, one or more classification stimuli.

The user device 302 requests 335 content (e.g., item recommendations) from the online system 140. The requested content is used to populate an ordering interface of the user device 302. The user device 302 may request content multiple times during a single shopping session. For example, the user device 302 may request content responsive to a user initially opening the ordering interface, responsive to a query for items from the user, responsive to moving to checkout, etc. In this manner, the ordering interface provides multiple opportunities (e.g., storefront, during checkout, searching for items, etc.) for the online system 140 to present item recommendations for items of particular classifications that are subject to corresponding at least one classification stimulus, and in some cases also present one or more classification stimuli (e.g., incentives, deals, promotions, etc.) or the classifications associated with the items. While not shown in FIGS. 3A-3B, in some embodiments, steps 305-330 may be performed responsive to the request for content from the user device 302.

The online system 140 selects 340 a classification of items that is subject to a classification stimulus from the set of classifications of items that is associated with that user. The online system 140 may determine one or more classifications of the set of classifications of items that is associated with the user that are also in the stimulus data (i.e., the set of classifications that each have at least one stimulus), where the determined one or more classifications form a subset. The content presentation module 210 may rank the one or more classifications in accordance with their respective scores. The content presentation module 210 may select a classification of items from the subset based in part on its rank. For example, the content presentation module 210 may select, from the subset, a classification of items that has the highest rank. In this manner, the online system 140 can narrow the set of classifications of items to a subset that only includes classifications that are subject to at least one stimulus, and select from this subset a classification that a user is most likely to have interest in (e.g., purchase an item of the selected classification). Moreover, the subset may be formed from classifications that are new classifications or rarely used classifications, thereby potentially expanding a scope of which items the user purchases during an online shopping session.

The online system 140 selects 345 one or more items belonging to the selected classification. For example, the online system 140 may use an item selection model or an availability model to select items from the classification.

The online system 140 provides 350 one or more item recommendations to the user device 302 for the one or more items belonging to the selected classification. The online system 140 selects one or more items belonging to the selected classification of items for providing to the user client device. The online system 140 generates an item recommendation for each of the selected items and provides the generated item recommendation(s) to the user device 302. In some embodiments the online system 140 may generate an item carousel that only includes item recommendations for the one or more items of the selected classification, and provide the item carousel to the user device 302 for presentation. In some embodiments, the online system 140 also provides, for presentation, the selected classification or the classification stimulus of the selected classification to the user device 302.

The user device 302 presents 355 the one or more item recommendations received from the online system 140. The user device 302 presents the one or more item recommendations via the ordering interface. The ordering interface may present the one or more item recommendations as part of an item carousel (e.g., it may also be received from the online system 140). In this manner, the item carousel may present item recommendations that are all subject to the classification stimulus. In some embodiments, the user device 302 may also present the classification stimulus associated with the one or more items or the classification of the one or more items. The user may then proceed with their shopping session.

The online system 140 may determine 360 feedback that is based in part on presentation of the one or more item recommendations by the user device 302. The feedback may describe actions (e.g., purchase item, click into item recommendation, etc.) of the user responsive to, e.g., presentation of an item recommendation associated with a classification subject to a classification stimulus, presentation of the classification stimulus associated with the item recommendation, or both.

The online system 140 may generate 365 additional training examples using the feedback. In some embodiments, the online system 140 may generate the additional training examples based in part on feedback determined for other users as well. The online system 140 may fine tune 370 (e.g., using the machine-learning training module 230) the classification preference model 250 using the additional training examples, which may cause the classification preference model 250 to improve continuously based on the determined user feedback.

FIG. 4 illustrates an example ordering interface 400 presenting a classification stimulus 405 and an item carousel 410 for items subject to the classification stimulus 405, in accordance with some embodiments. The ordering interface 400 is an embodiment of the interface described above with regard to FIGS. 1, 2, 3A, and 3B. The ordering interface 400 may be presented on a user device (e.g., the user client device 100). In the illustrated embodiment, the ordering interface 400 includes a classification stimulus area 415, and an item area 420 that includes the item carousel 410. In other embodiments, the ordering interface 400 includes different or additional elements. In addition, the functions may be distributed among the elements in a different manner than described.

The classification stimulus area 415 presents information describing the classification stimulus 405. The classification stimulus 405 applies to items of a particular classification. In the illustrated example, the classification stimulus 405 is an incentive for purchasing items that are part of a “Household Items” classification, specifically, $15 dollars off of Household Items, if at least $50 dollars of Household Items are purchased. In other embodiments, the classification stimulus 405 may be some other incentive, promotion, deal, etc., that applies to items that have a common classification (which may be different from Household Items). In the illustrated embodiment, the classification stimulus area 415 is presented near a top of the ordering interface 400. In other embodiments, the classification stimulus area 415 may be omitted or located in some other region of the ordering interface 400.

The item area 420 presents information describing item recommendations (e.g., item recommendation 425) for items that a user may order. The item recommendations may be presented using, e.g., one or more item carousels. For example, in FIG. 4, the ordering interface includes the item carousel 410 which presents item recommendations for items that are part of the Household Items classification and are subject to the classification stimulus 405.

The user may search the online system 140 for additional items using, e.g., a search option 430. The online system 140 may provide an updated list of item recommendations responsive to a received search request that are presented via the ordering interface 400. The user may also select items from an updated list of items to add to an ordering list.

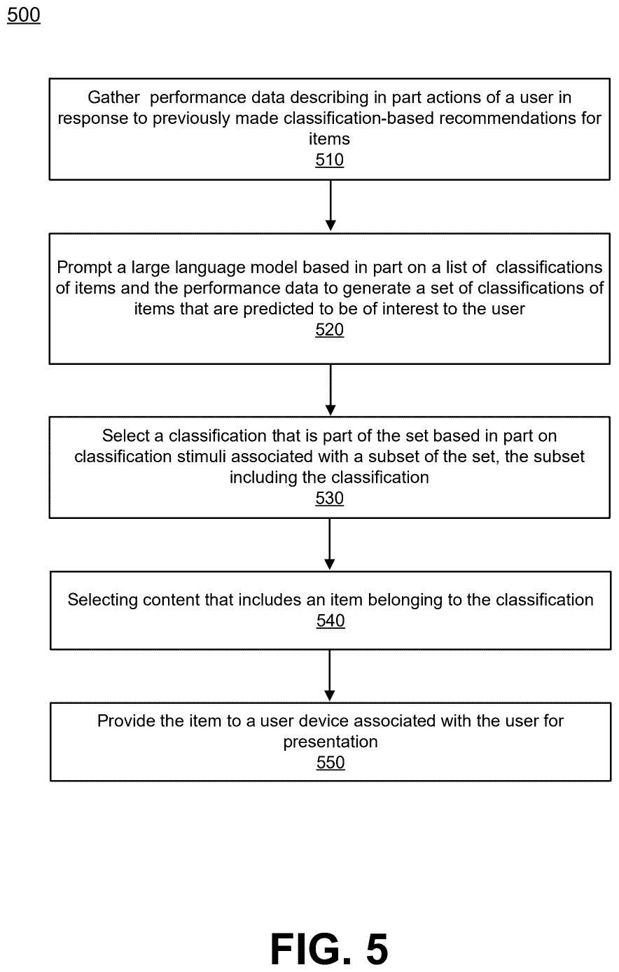

FIG. 5 is a flowchart for a method of leveraging a classification preference model and classification stimuli to make item recommendations that are subject to at least one classification stimulus, in accordance with some embodiments. Alternative embodiments may include more, fewer, or different steps from those illustrated in FIG. 5, and the steps may be performed in a different order from that illustrated in FIG. 5. These steps may be performed by an online system (e.g., online system 140). Additionally, each of these steps may be performed automatically by the online system without human intervention.

The online system 140 gathers 510 performance data that describes in part actions of a user in response to previously made classification stimulus-based item recommendations. In some embodiments, the online system 140 may determine the performance data based in part on feedback previously determined from actions of the user in response to previously made classification stimulus-based item recommendations. In some embodiments, the online system 140 may retrieve performance data that had been previously determined from a data store (e.g., the data store 240).

The online system 140 prompts 520 a LLM (e.g., the classification preference model 250) based in part on a list of classifications of items (i.e., classification data) and the performance data to generate a set of classifications of items that are predicted to be of interest to the user. Responsive to the prompt, the LLM outputs a set of classifications of items that are predicted to be of interest to the user, where each classification has a corresponding score. In some embodiments, the set of classifications of items is composed of new classifications or rarely used classifications. The set of classification of items may be referred to as a “first set.”

The online system 140 selects 530 a classification that is part of the first set based in part on classification stimuli associated with a subset of the first set, and the subset includes the classification. The online system 140 retrieves stimulus data that describes a second set of one or more classifications of items which are subject to one or more classification stimuli. The online system 140 compares the second set to the first set to identify a subset of the first set, where the subset includes classifications that are in the first set and also in the second set. The online system 140 may rank the one or more classifications of the subset in accordance with their respective scores. The online system 140 may select a classification of items from the subset based in part on its rank. For example, the online system 140 may select a highest rank classification of the subset to be the selected classification.

The online system 140 selects 540 an item belonging to the classification. The online system 140 may use an item selection model or an availability model to select items from an online catalog of the online system 140 that belong to the classification.

The online system 140 provides 550 an item recommendation for the item to a user device associated with the user for presentation. The online system 140 generates an item recommendation for the selected item and provides the generated item recommendation to the user device. In some embodiments the online system 140 may generate an item carousel that includes the generated item recommendation, and provides the item carousel to the user device for presentation. In some embodiments, the online system 140 also provides, for presentation, the classification stimulus associated with the item of the item recommendation or the selected classification to the user device.

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that are issued on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium, comprising:
gathering performance data describing actions of a user in response to previously made classification stimulus-based item recommendations;
prompting a large language model (LLM) based in part on a list of classifications of items and the performance data to generate a set of classifications of items that are predicted to be of interest to the user;
selecting a classification that is part of the set based in part on classification stimuli associated with a subset of the set, the subset including the classification;
selecting an item belonging to the classification; and
providing an item recommendation for the item to a user device associated with the user for presentation.

2. The method of claim 1, wherein the classification is associated with a classification stimulus that is applicable for all items having the classification, and the method further comprises:
providing the classification stimulus to the user device for presentation, wherein the user device presents the item and the classification stimulus.

3. The method of claim 2, further comprising:
generating an item carousel that includes only item recommendations for items that are subject to the classification stimulus, the item carousel including the item recommendation,
wherein providing the item recommendation for the item to the user device, further comprises:
providing the item carousel to the user device.

4. The method of claim 1, wherein the LLM was trained by:
accessing a set of training examples that includes training performance data and training classification data;
applying the LLM to the set of training examples to generate a training output corresponding to a set of training classifications of items;
back-propagating one or more error terms obtained from one or more loss functions to update a set of parameters of the LLM, and one or more of the error terms are based on a difference between a label applied to a test interaction of the set of training examples and the set of training classifications of items; and
stopping the back-propagation after the one or more loss functions satisfy one or more criteria.

5. The method of claim 1, further comprising:
identifying feedback that is based in part on presentation of the item recommendation by the user device;
generating additional training examples based in part on the feedback; and
fine tuning the LLM using the additional training examples.

6. The method of claim 5, wherein the classification is associated with a classification stimulus that is applicable for all items having the classification, the method further comprising:
providing the classification stimulus to the user device for presentation, wherein the user device presents the item recommendation and the classification stimulus,
wherein the feedback is also based in part on presentation of the classification stimulus by the user device.

7. The method of claim 1, wherein prompting the LLM based in part on the list of classifications of items and the performance data to generate the set of classifications of items that are predicted to be of interest to the user, comprises:
gathering the performance data and the list of classifications;
generating a prompt for the LLM that requests the LLM to score each of the list of classifications of items based in part on the performance data; and
applying the prompt to the LLM to generate the set of classifications of items.

8. The method of claim 7, wherein selecting the classification that is part of the set based in part on the stimuli associated with the subset of the set, comprises:
generating a second set of classifications that each have at least one stimulus;
generating one or more classifications of the set that are also in the second set, wherein the one or more classifications form the subset;
ranking the one or more classifications in accordance with their respective scores; and
selecting the classification from the subset based in part on its rank.

9. The method of claim 1, further comprising:
receiving an opportunity to provide content to the user device;
wherein prompting the LLM based in part on the list of classifications of items, and the performance data to generate the set of classifications of items that are predicted to be of interest to the user is performed responsive to receiving the opportunity to provide content.

10. The method of claim 1, further comprising:
storing the set of classifications of items in a data store; and
responsive to receiving an opportunity to provide content to the user device, retrieving the set of classifications of items from the data store, wherein the retrieving occurs prior to the selection of the classification.

11. A computer program product comprising a non-transitory computer readable storage medium having instructions encoded thereon that, when executed by a processor of a computer system, cause the computer system to perform steps comprising:
gathering performance data describing actions of a user in response to previously made classification stimulus-based item recommendations;
prompting a large language model (LLM) based in part on a list of classifications of items and the performance data to generate a set of classifications of items that are predicted to be of interest to the user;
selecting a classification that is part of the set based in part on classification stimuli associated with a subset of the set, the subset including the classification;
selecting an item belonging to the classification; and
providing an item recommendation for the item to a user device associated with the user for presentation.

12. The computer program product of claim 11, wherein the classification is associated with a classification stimulus that is applicable for all items having the classification, and the computer program product further comprises encoded instructions that when executed cause the computer system to perform steps comprising:
providing the classification stimulus to the user device for presentation, wherein the user device presents the item and the classification stimulus.

13. The computer program product of claim 12, further comprising encoded instructions that when executed cause the computer system to perform steps comprising:
generating an item carousel that includes only item recommendations for items that are subject to the classification stimulus, the item carousel including the item recommendation,
wherein the encoded instructions for providing the item recommendation for the item to the user device cause the computer system to perform steps comprising:
providing the item carousel to the user device.

14. The computer program product of claim 11, wherein the LLM was trained by:
accessing a set of training examples that includes training performance data and training classification data;
applying the LLM to the set of training examples to generate a training output corresponding to a set of training classifications of items;
back-propagating one or more error terms obtained from one or more loss functions to update a set of parameters of the LLM, and one or more of the error terms are based on a difference between a label applied to a test interaction of the set of training examples and the set of training classifications of items; and
stopping the back-propagation after the one or more loss functions satisfy one or more criteria.

15. The computer program product of claim 11, further comprising encoded instructions that when executed cause the computer system to perform steps comprising:
identifying feedback that is based in part on presentation of the item recommendation by the user device;
generating additional training examples based in part on the feedback; and
fine tuning the LLM using the additional training examples.

16. The computer program product of claim 15, wherein the classification is associated with a classification stimulus that is applicable for all items having the classification, and the computer program product further comprises encoded instructions that when executed cause the computer system to perform steps comprising:
providing the classification stimulus to the user device for presentation, wherein the user device presents the item recommendation and the classification stimulus,
wherein the feedback is also based in part on presentation of the classification stimulus by the user device.

17. The computer program product of claim 11, wherein the encoded instructions for prompting the LLM based in part on the list of classifications of items and the performance data to generate the set of classifications of items that are predicted to be of interest to the user cause the computer system to perform steps comprising:
gathering the performance data and the list of classifications;
generating a prompt for the LLM that requests the LLM to score each of the list of classifications of items based in part on the performance data; and
applying the prompt to the LLM to generate the set of classifications of items.

18. The computer program product of claim 17, wherein the encoded instructions for selecting the classification that is part of the set based in part on the stimuli associated with the subset of the set cause the computer system to perform steps comprising:
generating a second set of classifications that each have at least one stimulus;
generating one or more classifications of the set that are also in the second set, wherein the one or more classifications form the subset;
ranking the one or more classifications in accordance with their respective scores; and
selecting the classification from the subset based in part on its rank.

19. The computer program product of claim 11, further comprising encoded instructions that when executed cause the computer system to perform steps comprising:
storing the set of classifications of items in a data store; and
responsive to receiving an opportunity to provide content to the user device, retrieving the set of classifications of items from the data store, wherein the retrieving occurs prior to the selection of the classification.

20. A computer system comprising:
a processor; and
a non-transitory computer readable storage medium having instructions encoded thereon that, when executed by the processor, cause the computer system to perform steps comprising:
gathering performance data describing actions of a user in response to previously made classification stimulus-based item recommendations,
prompting a large language model (LLM) based in part on a list of classifications of items and the performance data to generate a set of classifications of items that are predicted to be of interest to the user,
selecting a classification that is part of the set based in part on classification stimuli associated with a subset of the set, the subset including the classification,
selecting an item belonging to the classification, and
providing an item recommendation for the item to a user device associated with the user for presentation.
